(19) United States
(12) Patent Application Publication
(10) Pub. No.: US 2026/0237295 A1
(43) Pub. Date: Aug. 13, 2026

(54) SYSTEM AND METHOD FOR INFERRING DRIVING TENDENCIES OF VEHICLES ON THE ROAD AND ROADSIDE UNITS FOR PERFORMING THE SAME

(71) Applicant: FOUNDATION OF SOONGSIL UNIVERSITY-INDUSTRY COOPERATION, Seoul (KR)

(72) Inventors: MINHAE KWON, Seoul (KR); SANGEUN PARK, Seoul (KR); CHANIN EOM, Seoul (KR)

(21) Appl. No.: 19/184,047

(22) Filed: Apr. 21, 2025

(30) Foreign Application Priority Data
Feb. 12, 2025 (KR) 10-2025-0018301

(51) Int. Cl. G08G 1/01; H04W 4/40

(52) U.S. Cl. CPC G08G 1/0116; H04W 4/40

(57) ABSTRACT

A system for inferring driving tendencies of vehicles includes roadside units (RSUs) installed around a road and configured to collect traveling information about a target vehicle on the road, and infer driving tendencies of the target vehicle based on the collected traveling information of the target vehicle, and vehicles configured to receive information about the driving tendencies of the target vehicle from the RSUs.

### CROSS-REFERENCE TO RELATED APPLICATION AND CLAIM OF PRIORITY

This application claims the benefit under 35 USC § 119 (a) of Korean Patent Application No. 10-2025-0018301 filed on Feb. 12, 2025 in the Korean Intellectual Property Office, the entire disclosure of which is incorporated herein by reference for all purposes.

### BACKGROUND

### 1. Field

Embodiments of the present disclosure relate to a technology for inferring driving tendencies of a vehicle on a road.

### 2. Description of Related Art

Recently, with the growth of autonomous driving technology, discussions on the commercialization of autonomous vehicles continue to take place. The commercialization of autonomous vehicles naturally creates a road environment where autonomous vehicles and non-autonomous vehicles are mixed and traveled. If the driving tendencies of adjacent vehicles may be identified in such a road environment, not only can the driving stability of both autonomous vehicles and non-autonomous vehicles be improved, but also the flow of traffic can be made smooth, and thus a method for identifying the driving tendencies of adjacent vehicles is required.

Examples of related art include Korean Unexamined Patent Application Publication No. 10-2024-0122941 (2024.08.13).

### SUMMARY

Embodiments of the present disclosure are intended to provide a system and method for inferring driving tendencies of a vehicle on a road and a roadside unit (RSU) for performing the same.

According to an exemplary embodiment of the present disclosure, there is provided a system for inferring driving tendencies of vehicles, the system including RSUs installed around a road and configured to collect traveling information about a target vehicle on the road, and infer driving tendencies of the target vehicle based on the collected traveling information of the target vehicle, and vehicles configured to receive information about the driving tendencies of the target vehicle from the RSUs.

The RSUs each may include an information collection module configured to collect the traveling information about the target vehicle on the road within an observation range of the RSU, a preprocessing module configured to preprocess the traveling information of the target vehicle to generate processed information including target vehicle-related information and environment range-related information, and an inference module configured to input the processed information into a pre-trained artificial neural network model to infer the driving tendencies of the target vehicle.

The target vehicle-related information may include a speed of the target vehicle, a position of the target vehicle, and a current lane of the target vehicle, and the environment range-related information may include a relative speed to an adjacent vehicle, a relative distance to an adjacent vehicle, the density for each forward, and a travelable distance within a preset environment range set based on the target vehicle.

The RSU each may further include a first communication module configured to transmit the collected traveling information of the target vehicle to an adjacent RSU positioned in a traveling direction of the target vehicle and a second communication module configured to transmit information about the driving tendencies of the target vehicle to a vehicle adjacent to the target vehicle on the road.

The first communication module may be configured to transmit traveling information of the target vehicle collected within the observation range of the RSU to an adjacent RSU positioned in the traveling direction of the target vehicle when the target vehicle leaves the observation range of the RSU in a state in which the collected traveling information of the target vehicle is collected in an amount less than or equal to a preset cumulative threshold amount.

The RSUs each may further include a training module configured to collect traveling information about vehicles to construct a training dataset and train the artificial neural network model using the training dataset.

The training module may be configured to generate, when no label for driving tendencies of a vehicle of interest is present in training data, classification basic information including one or more of a relative distance from a vehicle ahead in the same lane as the vehicle of interest, a speed of the vehicle of interest, lateral acceleration of the vehicle of interest, and longitudinal acceleration of the vehicle of interest based on traveling information of the vehicle of interest for which no label for the driving tendencies is present, classify the vehicle of interest into one of preset clusters using the classification basic information, and generate a pseudo label according to the classified cluster.

The training module may be configured to add noise to each training data for each vehicle to learn about noise generated during a sensing process.

The training module may be configured to add noise to training data for each vehicle with smaller noise as a distance between an RSU and a vehicle of interest is closer, and add noise to the training data for each vehicle with larger noise as the distance between the RSU and the vehicle of interest is farther.

According to another exemplary embodiment of the present disclosure, there is provided a method for inferring driving tendencies of vehicles performed by a RSU including one or more processors and a memory storing one or more programs executed by the one or more processors, the method including collecting traveling information about a target vehicle on a road, inferring driving tendencies of the target vehicle based on the collected driving information of the target vehicle, and transmitting the driving tendencies of the target vehicle to a vehicle adjacent to the target vehicle on the road.

According to still another exemplary embodiment of the present disclosure, there is provided a RSU installed around a road, including an information collection module configured to collect traveling information about a target vehicle on the road within a preset observation range, a preprocessing module configured to preprocess the traveling information of the target vehicle to generate processed information including target vehicle-related information and environment range-related information, and an inference module configured to input the processed information into a pre-trained artificial neural network model to infer the driving tendencies of the target vehicle.

### BRIEF DESCRIPTION OF THE DRAWINGS

FIG. 1 is a diagram illustrating a system for inferring driving tendencies of vehicles on a road according to an embodiment of the present disclosure.

FIG. 2 is a block diagram illustrating a configuration of an RSU according to an embodiment of the present disclosure.

FIG. 3 is a diagram schematically illustrating a communication situation between RSUs in an embodiment of the present disclosure.

FIG. 4 is a diagram for describing processed information in an embodiment of the present disclosure.

FIGS. 5A to 5D are diagrams illustrating a state of inferring driving tendencies in various types of artificial neural network models according to an embodiment of the present disclosure.

FIGS. 6A and 6B are diagrams illustrating a state of clustering classification basic information of a vehicle in an embodiment of the present disclosure.

FIG. 7 is a block diagram for illustratively describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or workers. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In addition, the terms “first”, “second”, etc. may be used to describe various components, but the components should not be limited by the terms. The terms may be used to distinguish one component from another. For example, without departing from the scope of the present disclosure, a first component may be referred to as a second component, and similarly, a second component may also be referred to as a first component.

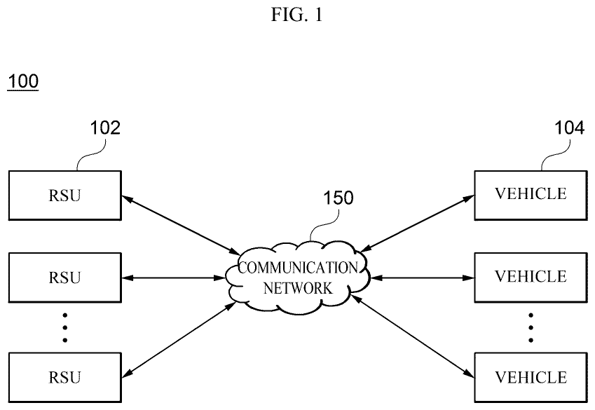

FIG. 1 is a diagram illustrating a system for inferring driving tendencies of vehicles on a road according to an embodiment of the present disclosure.

Referring to FIG. 1, a system for inferring driving tendencies 100 includes RSUs 102 and vehicles 104. Here, each RSU 102 and each vehicle 104 may be communicatively connected to each other via a communication network 150.

The communication network 150 may include the Internet, one or more local area networks, wide area networks, cellular networks, mobile networks, other types of networks, or a combination of these networks.

The RSU 102 may be installed around the road as a roadside device. The RSU 102 may be provided to collect information on the road. In an embodiment, the RSU 102 may be installed on the outside of the road, or may be installed on an upper part of the road through a separate support.

The RSU 102 may collect traveling information on a target vehicle on the road, and may infer driving tendencies of the target vehicle based on the traveling information of the target vehicle. The RSU 102 may transmit the traveling information of the target vehicle to an adjacent RSU 102 positioned in the traveling direction of the target vehicle. The RSU 102 may transmit information about the driving tendencies of the target vehicle (driving tendency information) to vehicles adjacent to the target vehicle on the road.

In the disclosed embodiment, the driving tendencies of the target vehicle may mean driving tendencies of a driver driving a target vehicle. In this case, the driving tendencies may include a traveling pattern that appears when the driver directly operates the vehicle or a traveling pattern that appears in the vehicle by the driver's traveling command (e.g., settings for autonomous traveling input by the driver).

In an embodiment, the driving tendencies may be divided into a conservative tendency, a neutral tendency, and an aggressive tendency. The conservative tendency may be a driving tendency of having a stopping distance between vehicles, maintaining stable traveling even in a situation where traffic congestion is low, and minimizing lane change. The neutral tendency may be a driving tendency of having a shorter stopping distance between vehicles than that of the conservative tendency, stably performing traveling in case of traffic congestion, and performing traveling to achieve a target speed in a smooth road environment. The aggressive tendency may be a driving tendency of having a shorter stopping distance between vehicles than that of the neutral tendency, maintaining high speed while following the acceleration of a vehicle ahead, and frequently changing lanes. Here, the stopping distance between vehicles may mean a distance between a vehicle in question and a vehicle ahead in the same lane.

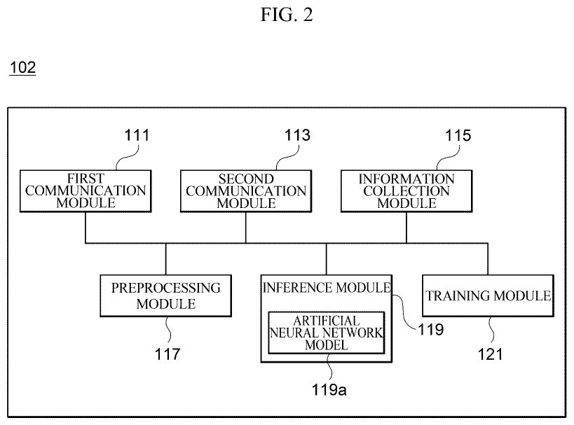

FIG. 2 is a block diagram illustrating a configuration of the RSU 102 according to an embodiment of the present disclosure. Referring to FIG. 2, the RSU 102 may include a first communication module 111, a second communication module 113, an information collection module 115, a preprocessing module 117, an inference module 119, and a training module 121.

The first communication module 111 may perform communication with an adjacent RSU 102. In an embodiment, the first communication module 111 may perform communication between RSUs through Infrastructure-to-Infrastructure communication (I2I). The first communication module 111 may transmit the traveling information of the target vehicle collected by the information collection module 115 to an adjacent RSU 102 positioned in a traveling direction of the target vehicle. In an embodiment, the target vehicle may include all vehicles on the road.

The first communication module 111 may transmit the traveling information of the target vehicle collected within the observation range to an adjacent RSU 102 positioned in the traveling direction of the target vehicle when the target vehicle of the RSU 102 leaves the observation range in a state where the traveling information of the target vehicle is collected in an amount less than or equal to a preset cumulative threshold amount.

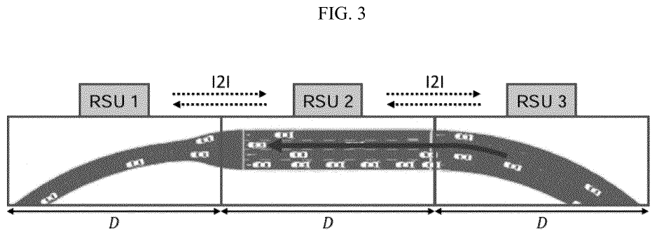

FIG. 3 is a diagram schematically illustrating a communication situation between RSUs in an embodiment of the present disclosure. Referring to FIG. 3, RSU 3 may collect traveling information of a target vehicle in its observation range D. The traveling information of the target vehicle may be collected from a point in time when RSU 3 recognizes the target vehicle.

RSU 3 may transmit the traveling information of the target vehicle collected during that time period to RSU 2 positioned in the traveling direction of the target vehicle when the target vehicle leaves the observation range of RSU 3 in a state where the traveling information of the target vehicle is collected in an amount less than or equal to a preset cumulative threshold amount. Here, the cumulative threshold amount may mean the total amount of data of the collected traveling information or may mean a cumulative time length of the collected traveling information.

RSU 2 may infer the driving tendencies of the target vehicle when the traveling information of the target vehicle received from RSU 3 and the traveling information of the target vehicle collected by RSU 2 exceed the preset cumulative threshold amount. RSU 2 may transmit the traveling information of the target vehicle received from RSU 3 and the traveling information of the target vehicle collected by RSU 2 to RSU 1 positioned in the traveling direction of the target vehicle when the amount of the traveling information of the target vehicle received from RSU 3 and the traveling information of the target vehicle collected by RSU 2 is less than or equal to the preset cumulative threshold amount. In this way, by performing communication between RSUs 102 and transmitting the traveling information of the target vehicle, the traveling information of the target vehicle may be collected without restrictions on the observation range of the RSU 102.

The second communication module 113 may perform communication with the vehicle 104 on the road. In an embodiment, the second communication module 113 may perform communication with the vehicle 104 through vehicle-to-infrastructure (V2I). The second communication module 113 may transmit driving tendency information of the target vehicle to each vehicle 104 adjacent to the target vehicle. In an embodiment, the target vehicle may be any vehicle 104 on the road, and in this case, each vehicle 104 on the road receives driving tendency information of the vehicle 104 adjacent to the vehicle.

The information collection module 115 may collect driving information about the target vehicle on the road within the observation range of the RSU 102. The information collection module 115 may be equipped with observation means such as a camera, radar, and a measurement sensor to collect the traveling information of the target vehicle. Here, the observation range of the RSU 102 may be determined by a range that the observation means can observe.

The information collection module 115 may collect the traveling information of the target vehicle through one or more observation means. The information collection module 102 may recognize a vehicle number to identify each target vehicle. The information collection module 115 may collect traveling information including the position of the target vehicle, the lane of the target vehicle on the road, the speed of the target vehicle, etc.

In an embodiment, the information collection module 102 may collect the traveling information of the target vehicle at preset time intervals. In this case, the traveling information of the target vehicle may be trajectory data having a preset time length. The trajectory data may be defined as time series data including data of each time step from a specific point in time to a point in time at which a predetermined time elapses. In this case, a time length of the trajectory data may be determined by the type, performance, accuracy, etc. of an artificial neural network model which will be described below. The information collection module 115 is equipped with a buffer in the form of a queue to temporarily store trajectory data having a preset time length.

The preprocessing module 117 may preprocess the traveling information of the target vehicle having the preset time length. The preprocessing module 117 may process the traveling information of the target vehicle having a preset time length into information for training or inferring the artificial neural network model. The artificial neural network model may be a model trained to infer the driving tendencies of the target vehicle.

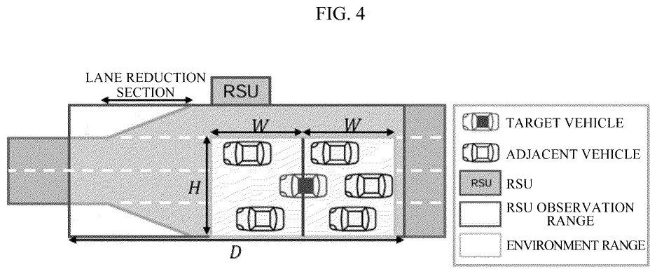

The preprocessing module 117 may preprocess the traveling information of the target vehicle having a preset time length to generate processed information in units of preset time steps. Here, the processed information may include target vehicle-related information and environment range-related information for the target vehicle. FIG. 4 is a diagram for describing processed information in an embodiment of the present disclosure, and FIG. 4 illustrates an observable range of the RSU and the environment range for the target vehicle.

Meanwhile, processed information dt at time step t may be represented by Equation 1 below.

$${d}_{t} = {[ {d}_{t , target}^{T} , {d}_{t , env}^{T} ]}^{T} \qquad Equation 1$$

$${d}_{t , target} : target vehicle - related information$$

$${d}_{t , env} : environment range - related information$$

Here, the target vehicle-related information may include the speed of the target vehicle, the position of the target vehicle, and the current lane of the target vehicle. The target vehicle-related information may be represented by Equation 2.

$${d}_{t , target} = {[ {v}_{t , target} , {p}_{t , target} , {h}_{t , target} ]}^{T} \qquad Equation 2$$

$${v}_{t , target} : speed of target vehicle$$

$${p}_{t , target} : position of target vehicle$$

$${h}_{t , target} : current lane of target vehicle$$

In addition, the environment range-related information may include information about vehicles and space within an environment range that may affect the behavior of the target vehicle. In an embodiment, the environment range-related information may include a relative speed to an adjacent vehicle, a relative distance to an adjacent vehicle, the density for each forward lane, and a travelable distance. The environment range-related information may be represented by Equation 3.

$${d}_{t , env} = {[ Δ {v}_{t}^{T} , Δ {p}_{t}^{T} , {ρ}_{t}^{T} , {ζ}_{t}^{T} ]}^{T} \qquad Equation 3$$

$$Δ {v}_{t} : relative speed to adjacent vehicle$$

$$Δ {p}_{t} : relative distance to adjacent vehicle$$

$${ρ}_{t} : density for each forward lane$$

$${ζ}_{t} : travelable distance$$

Here, the relative speed to the adjacent vehicle may mean the relative speed of the target vehicle to each adjacent vehicle within a preset environment range. The relative speed to the adjacent vehicle may be represented by Δvₜ=[Δv_{t,l}_{₁}, . . . , Δv_{t,l}_{_{H}}, Δv_{t,f}_{₁}, . . . , Δv_{t,f}_{_{H}}]^{T}. The environment range is a region set based on the position of the target vehicle (e.g., a region in the shape of a square or a circle), and may be set as a range that affects the target vehicle. In an embodiment, the environment range may be set through an area H corresponding to a certain number of lanes and a certain distance between forward and rearward points 2W based on the position of the target vehicle.

The relative distance to the adjacent vehicle may mean a distance between each adjacent vehicle and the target vehicle within a preset environment range. The relative distance to the adjacent vehicle Δpₜ may be represented by Δpₜ=[Δp_{t,l}_{₁}, . . . , Δp_{t,l}_{_{H}}, Δp_{t,f}_{₁}, . . . , Δp_{t,f}_{_{H}}]^{T}.

The density for each forward lane ρₜ may mean the density of vehicles for each lane in the forward side of the target vehicle within the preset environment range. The density for each forward lane ρ_{t,h} for lane h may be represented by

$${ρ}_{t , h} ∝ \frac{\vert {K}_{t , {l}_{h}} \vert}{W} .$$

|K_{t,l}_{ₕ}| means the number of vehicles positioned forward of the target vehicle in the lane h within the environment range. W means a preset forward distance within the environment range based on the target vehicle.

The travelable distance may mean a travelable road length of each lane extending in the forward direction of the target vehicle within the preset environment range. The travelable distance ζₜ may be represented by ζₜ=[ζ_{t,1}, ζ_{t,2}, . . . , ζ_{t,H}]^{T}. The travelable distance may be defined as +W when the lane is maintained within the environment range, and may be defined as 0 when the lane does not exist. When the travelable road length is shorter than a forward observation range, ζₜ may be defined in the range of [0, +W].

In an embodiment, the preprocessing module 117 may construct processed information in units of time steps for a preset time period as time series data. That is, the preprocessing module 117 may combine processed information in units of time steps for a certain time period to be constructed as trajectory data, which is time series data. The preprocessing module 117 may construct time series data including processed information in units of time steps for a certain time period from a specific point in time a to T time. In this case, the time series data may be represented by

$${\{ {d}_{t} \}}_{t = α}^{α + T} .$$

Time series data (i.e., trajectory data) for a certain time period may be used as input to the artificial neural network model. However, the preset disclosure is not limited thereto, and processed information of each time step may become input of the artificial neural network model depending on the type of the artificial neural network model.

The inference module 117 may infer the driving tendencies of the target vehicle by inputting the processed information (processed information for a certain time period or processed information for each time step) generated by the preprocessing module 104 into a pre-trained artificial neural network model 119a. Information about the driving tendencies of the target vehicle inferred by the inference module 119 may be transmitted to each vehicle 104 adjacent to the target vehicle through the second communication module 113.

The training module 121 may play a role in training the artificial neural network model 119a for inferring the driving tendencies of the vehicle. The training module 121 may collect traveling information about vehicles on the road (including both vehicles on actual roads and vehicles on roads in a virtual environment) and construct a training dataset for training the artificial neural network model 119a. In this case, traveling information for vehicles may be collected using the RSU, but is not limited thereto, and may also be collected through a drone, a vehicle, a simulator, or the like.

The training module 121 may preprocess traveling information of a vehicle having a preset time length to generate processed information in units of preset time steps. The processed information may include vehicle-related information and environment range-related information for each vehicle. The training module 121 may train the artificial neural network model 119a based on the generated processed information.

The artificial neural network model 119a may be trained to classify the driving tendencies of the vehicle using processed information as input. In an embodiment, the artificial neural network model 119a may be a model based on one of a Transformer, a Long Short Term Memory (LSTM), and an extended LSTM (xLSTM). In this case, the processed information input to the artificial neural network model 119a may be processed information for a certain time period (i.e., trajectory data having a certain time length)

$${\{ {d}_{t} \}}_{t = α}^{α + T} .$$

However, the present disclosure is not limited thereto, and the artificial neural network model 119a may be a multi-layer perceptron (MLP). In this case, the processed information input to the artificial neural network model 119a may be processed information at each time step, i.e., processed information for a single point in time.

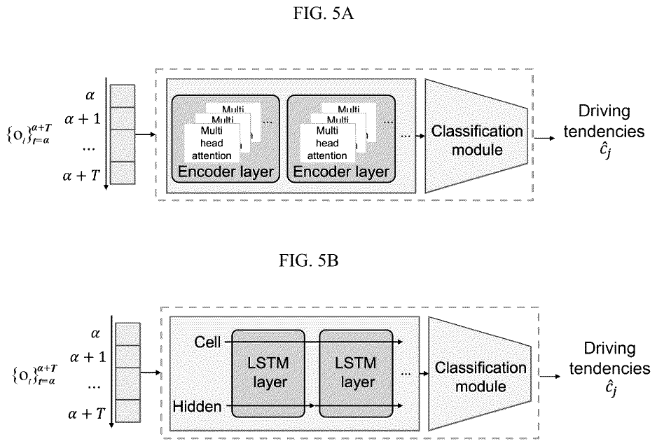

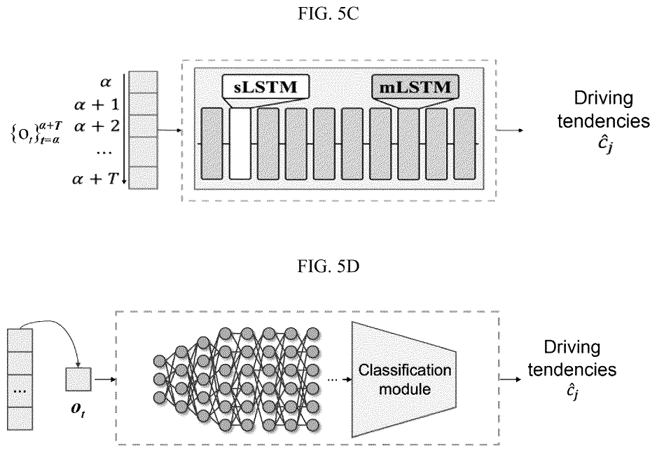

FIGS. 5A to 5D are diagrams illustrating a state of inferring driving tendencies in various types of artificial neural network models according to an embodiment of the present disclosure. FIGS. 5A to 5C respectively show cases where the artificial neural network model 119a is the transformer, the Long Short Term Memory (LSTM), and the extended LSTM (xLSTM). In this case, the processed information

$${\{ {d}_{t} \}}_{t = α}^{α + T} ,$$

which is trajectory data for a certain time period, is input to the artificial neural network model 119a, and the driving tendencies of the vehicle are inferred from the input processed information.

FIG. 5D shows the case where the artificial neural network model 119a is the multi-layer perceptron (MLP), and the processed information at each time step is input to the artificial neural network model 119a, and the driving tendencies of the vehicle are inferred from the input processed information. Hereinafter, for convenience of description, an example that data input to the artificial neural network model 119a is processed information for a predetermined time period will be described.

When training the artificial neural network model 119a, the training module 121 may generate a pseudo label for a vehicle of interest when no label for the driving tendencies of the vehicle of interest is present in the training data. Specifically, the training module 121 may generate a pseudo label for the driving tendencies for the vehicle of interest based on the traveling information of the vehicle for which no label for the driving tendencies is present.

The training module 121 may generate classification basic information for classifying the pseudo label of the vehicle of interest for which no label is present based on the traveling information of the vehicle. Here, the classification basic information may include the relative distance from a vehicle ahead in the same lane as a vehicle of interest, the speed of the vehicle of interest, the lateral acceleration of the vehicle of interest, and the longitudinal acceleration of the vehicle of interest. The training module 121 may input classification basic information of the vehicle of interest into the K-means clustering algorithm to generate a pseudo label for the vehicle of interest.

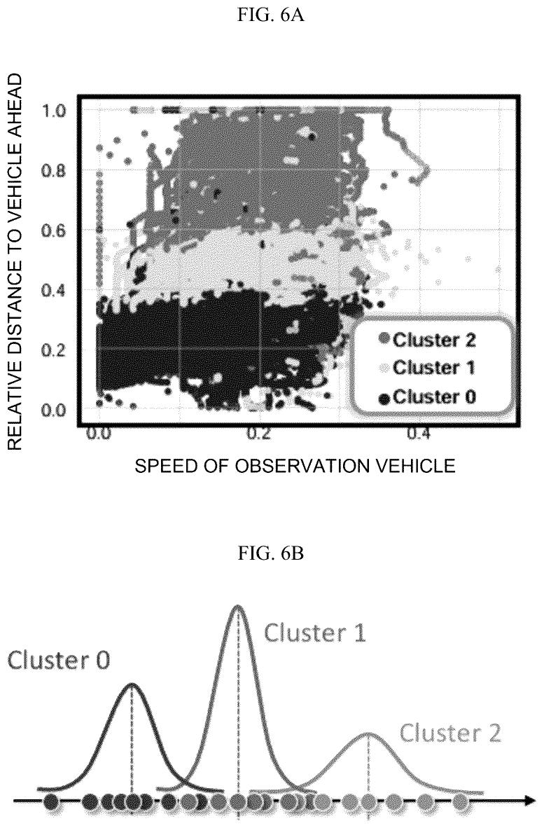

In addition, the training module 121 may input the classification basic information of the vehicle of interest into a Gaussian mixture model to classify clusters and generate a pseudo label through this classification. FIGS. 6A and 6B are diagrams illustrating a state of clustering classification basic information of a vehicle in an embodiment of the present disclosure. FIG. 6A shows a case where the K-means clustering is used, and FIG. 6B shows a case where clustering is done using a Gaussian mixture model. In the above two methods, the vehicle of interest may be classified into any one of clusters of Cluster 0 (conservative tendency), Cluster 1 (neutral tendency), and Cluster 2 (aggressive tendency), and a pseudo label may be generated according to the classified cluster.

The training module 121 may add noise to the training data when training the artificial neural network model 119a. That is, when collecting traveling information about a vehicle traveling on the road, since noise may be contained in the traveling information in a sensing process or communication process, noise may be intentionally added to training data for noise-robust training. By training the artificial neural network model 119a through training data with added noise in this way, the driving tendencies of the vehicle can be effectively inferred even if noise is contained in information collected when inferring the driving tendencies of the vehicle.

In an embodiment, when processed information for a certain time period is used as training data, the training module 121 may generate processed information containing noise through Equation 4 below.

$${\{ {\tilde{d}}_{t} \}}_{t = α}^{α + T} ← {\{ {d}_{t} \}}_{t = a}^{α + T} + Noise \qquad Equation 4$$

$${\{ {\tilde{d}}_{t} \}}_{t = α}^{α + T} : processed information for a certain time period that contains noise$$

Here, the noise may be Gaussian noise. Gaussian noise is represented by

$$𝒩 ( 0 , {σ}_{t}^{2} ) ,$$

and may be randomly sampled from a normal distribution with a mean of 0 and a variance of

$${σ}_{t}^{2} .$$

That is, processed information may be generated by adding noise based on Gaussian distribution sampling. In addition, the noise may be set according to the distance between the RSU 102 and a vehicle of interest. That is, the closer the distance between the RSU 102 and the vehicle of interest, the smaller the noise, and the farther the distance between the RSU 102 and the vehicle of interest, the greater the noise.

In an embodiment, the training module 121 may input processed information containing noise into the artificial neural network model 119a and train the artificial neural network model 119a to infer the driving tendencies of the vehicle of interest. In this case, as a loss function for training the artificial neural network model 119a, a cross entropy loss function may be used. The artificial neural network model 119a may be trained using Equation 5 below.

$$f ← f - η ∇ {ℒ}_{CE} ( ( {\{ {\tilde{d}}_{t} \}}_{t = α}^{α + T} , {c}_{j} ) ; f ) \qquad Equation 5$$

$$f : artificial neural network model$$

$$η : learning rate$$

$${ℒ}_{CE} : cross entropy loss function$$

$${c}_{j} : correct answer class ( correct answer value ) for driving tendencies of vehicle$$

According to the disclosed embodiment, by inferring the driving tendencies of the target vehicle through the RSU 102 on the road and transmitting the inferred driving tendencies of the target vehicle to the adjacent vehicle of the target vehicle, each vehicle can travel in consideration of the driving tendencies of adjacent vehicles, and as a result, a smooth traffic flow can be induced on the road. In other words, the distance from the vehicle ahead or the number of lanes changes may be different depending on driving tendencies thereof, and even if the vehicle in the same situation shows different behavior patterns according to the driving tendencies, the driving tendencies of the other vehicle can be identified and used for decision making according to the vehicle operation.

In this specification, the term “module” may mean a functional and structural combination of hardware for performing the technical idea of the present invention and software for operating the hardware. For example, the “module” may mean a logical unit of a given code and hardware resources for performing the given code, and does not necessarily mean a physically connected code or a single type of hardware.

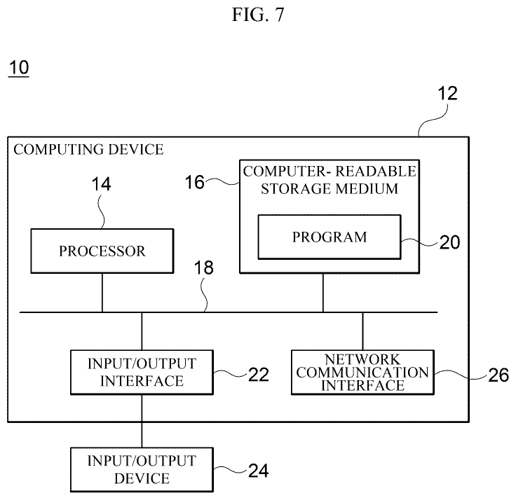

FIG. 7 is a block diagram for illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In an embodiment, the computing device 12 may be the RSU 102. In addition, the computing device 12 may be the vehicle 104.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, by inferring the driving tendencies of the target vehicle on the road, each vehicle can travel in consideration of the driving tendencies of adjacent vehicles, and as a result, a smooth traffic flow can be induced on the road. In particular, in the case of autonomous vehicles, appropriate decisions are made in consideration of the driving tendencies of adjacent vehicles, and as a result, a safe traffic environment can be established.

In the above, although representative embodiments of the present invention have been described in detail, those skilled in the art will understand that the present disclosure may be implemented in modified forms without departing from the essential characteristics of the present disclosure. Therefore, the scope of the present disclosure is not limited to the embodiments described above, but should be defined not only by the claims described below but also by equivalents of the claims.

What is claimed is:

1. A system for inferring driving tendencies of vehicles, comprising:
roadside units (RSUs) installed around a road and configured to collect traveling information about a target vehicle on the road, and infer driving tendencies of the target vehicle based on the collected traveling information of the target vehicle; and
vehicles configured to receive information about the driving tendencies of the target vehicle from the RSUs.

2. The system of claim 1, wherein the RSUs each include:
an information collection module configured to collect the traveling information about the target vehicle on the road within an observation range of the RSU;
a preprocessing module configured to preprocess the traveling information of the target vehicle to generate processed information including target vehicle-related information and environment range-related information; and
an inference module configured to input the processed information into a pre-trained artificial neural network model to infer the driving tendencies of the target vehicle.

3. The system of claim 2, wherein the target vehicle-related information includes a speed of the target vehicle, a position of the target vehicle, and a current lane of the target vehicle, and
the environment range-related information includes a relative speed to an adjacent vehicle, a relative distance to an adjacent vehicle, the density for each forward lane, and a travelable distance within a preset environment range set based on the target vehicle.

4. The system of claim 2, wherein the RSU each further include:
a first communication module configured to transmit the collected traveling information of the target vehicle to an adjacent RSU positioned in a traveling direction of the target vehicle; and
a second communication module configured to transmit information about the driving tendencies of the target vehicle to a vehicle adjacent to the target vehicle on the road.

5. The system of claim 4, wherein the first communication module is configured to transmit traveling information of the target vehicle collected within the observation range of the RSU to an adjacent RSU positioned in the traveling direction of the target vehicle when the target vehicle leaves the observation range of the RSU in a state in which the collected traveling information of the target vehicle is collected in an amount less than or equal to a preset cumulative threshold amount.

6. The system of claim 2, wherein the RSUs each further include a training module configured to collect traveling information about vehicles on a road to construct a training dataset and train the artificial neural network model using the training dataset.

7. The system of claim 6, wherein the training module is configured to generate, when no label for driving tendencies of a vehicle of interest is present in training data, classification basic information including one or more of a relative distance from a vehicle ahead in the same lane as the vehicle of interest, a speed of the vehicle of interest, lateral acceleration of the vehicle of interest, and longitudinal acceleration of the vehicle of interest based on traveling information of the vehicle of interest for which no label for the driving tendencies is present, classify the vehicle of interest into one of preset clusters using the classification basic information, and generate a pseudo label according to the classified cluster.

8. The system of claim 6, wherein the training module is configured to add noise to each training data for each vehicle to learn about noise generated during a sensing process.

9. The system of claim 8, wherein the training module is configured to add noise to training data for each vehicle with smaller noise as a distance between an RSU and a vehicle of interest is closer, and add noise to the training data for each vehicle with larger noise as the distance between the RSU and the vehicle of interest is farther.

10. A method for inferring driving tendencies of vehicles performed by a roadside unit (RSU) including one or more processors and a memory storing one or more programs executed by the one or more processors, the method comprising:
collecting traveling information about a target vehicle on a road;
inferring driving tendencies of the target vehicle based on the collected driving information of the target vehicle; and
transmitting the driving tendencies of the target vehicle to a vehicle adjacent to the target vehicle on the road.

11. A roadside unit (RSU) installed around a road, comprising:
an information collection module configured to collect traveling information about a target vehicle on the road within a preset observation range;
a preprocessing module configured to preprocess the traveling information of the target vehicle to generate processed information including target vehicle-related information and environment range-related information; and
an inference module configured to input the processed information into a pre-trained artificial neural network model to infer the driving tendencies of the target vehicle.
